(19) United States
(12) Patent Application Publication
(10) Pub. No.: US 2018/0276775 A1
(43) Pub. Date: Sep. 27, 2018

(54) SPACE UTILIZATION AND BUILDING MANAGEMENT SYSTEM ANALYSIS

(71) Applicant: Honeywell International Inc., Morris Plains, NJ (US)

(72) Inventors: Himanshu Khurana, Plymouth, MN (US); Daniel Kirschner, Naperville, IN (US)

(21) Appl. No.: 15/467,824

(22) Filed: Mar. 23, 2017

(51) Int. Cl. G06Q 50/16; G06Q 10/06

(52) U.S. Cl. CPC G06Q 50/163; G06Q 10/06395; G06Q 10/06315

(57) ABSTRACT

Devices, methods, and systems for space utilization and building management system analysis are described herein. One apparatus includes a memory, and a processor configured to receive data collected by a plurality of different types of existing systems associated with a facility, analyze a space utilization of the facility using the received data, and provide the analysis of the space utilization of the facility to a user.

### TECHNICAL FIELD

The present disclosure relates to devices, methods, and systems for space utilization and building management system analysis.

### BACKGROUND

Different spaces of a facility, such as, for instance, a commercial office building, may be utilized in different ways by different people. Understanding who is utilizing the different spaces of a facility, and how the spaces are being utilized, can be helpful in ensuring that the spaces are being used in an optimal (e.g., effective and/or efficient) manner.

In some previous approaches for determining and analyzing space utilization, an individual may walk through the spaces of a facility and manually track which chairs in the spaces are occupied, and which chairs in the spaces are vacant. However, such an approach may be time consuming, and may provide incomplete data that does not accurately reflect the actual utilization of the spaces.

In other previous approaches for determining and analyzing space utilization, new sensors may be installed in the facility for the specific purpose of collecting data on space utilization. However, the installation of such new sensors may be costly and/or difficult to incorporate into the existing infrastructure of the facility.

Further, the spaces of a facility may be monitored and/or controlled (e.g., by an operator, manager, and/or technician) using a building management system. For example, the building management system may be used to check and/or set the state of control components, equipment, devices, and/or networks associated with the different spaces of the facility. However, determining and analyzing the effectiveness of the building management system (e.g., whether the building management system is being used effectively to monitor and/or control the spaces of the building) can be difficult.

### BRIEF DESCRIPTION OF THE DRAWINGS

FIG. 1 illustrates an example of a system for space utilization and building management system analysis in accordance with one or more embodiments of the present disclosure.

FIG. 2 illustrates an example of a method for space utilization and building management system analysis in accordance with one or more embodiments of the present disclosure.

FIG. 3 illustrates an example of a computing device for space utilization and building management system analysis in accordance with one or more embodiments of the present disclosure.

FIG. 4 illustrates an example of a space utilization analysis provided to a user in accordance with one or more embodiments of the present disclosure.

FIG. 5 illustrates an example of a space utilization analysis provided to a user in accordance with one or more embodiments of the present disclosure.

### DETAILED DESCRIPTION

Devices, methods, and systems for space utilization and building management system analysis are described herein. For example, one or more embodiments include a memory, and a processor configured to execute executable instructions stored in the memory to receive data collected by a plurality of different types of existing systems associated with a facility, analyze a space utilization of the facility using the received data, and provide the analysis of the space utilization of the facility to a user.

Embodiments of the present disclosure can analyze the space utilization and/or building management system of a facility more accurately, easily, efficiently, and/or effectively than previous space utilization and/or building management system analysis approaches. For example, by using data collected by a plurality of systems associated with the facility to analyze the space utilization of the facility, embodiments of the present disclosure can provide a more accurate reflection of the actual utilization of the spaces of the facility than previous space analysis approaches. Further, by using data collected by existing (e.g., previously installed) systems associated with the facility (e.g., by not requiring the installation of new sensing systems) to analyze the space utilization and building management system of the facility, embodiments of the present disclosure may be less costly and/or easier to incorporate into the existing infrastructure of the facility than previous space utilization and/or building management system analysis approaches.

As such, embodiments of the present disclosure can be more helpful and/or more useful than previous approaches in determining and/or analyzing (e.g., understanding) whether the spaces of a facility are being effectively and/or efficiently utilized. For example, embodiments of the present disclosure can create and/or provide an increased (e.g., enhanced) awareness and/or understanding of the utilization (e.g., utilization level) of the spaces of a facility.

Further, embodiments of the present disclosure can be used to determine and/or analyze the space utilization and/or building management systems of a plurality of facilities. For example, embodiments of the present disclosure can determine and/or analyze the space utilization across an entire portfolio of facilities, which can create and/or provide an increased awareness and/or understanding of the space utilization across the portfolio.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

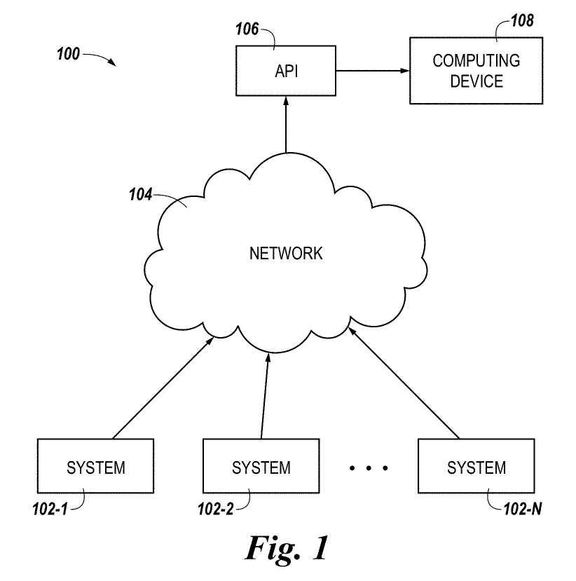

The figures herein follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 308 in FIG. 3.

As used herein, “a” or “a number of” something can refer to one or more such things, while “a plurality of” something can refer to more than one such things. For example, “a number of systems” can refer to one or more systems, while “a plurality of system” can refer to more than one system. Additionally, the designator “N” as used herein, particularly with respect to reference numerals in the drawings, indicates that a number of the particular feature so designated can be included with a number of embodiments of the present disclosure.

FIG. 1 illustrates an example of a system 100 for space utilization and building management system analysis in accordance with one or more embodiments of the present disclosure. As shown in FIG. 1, system 100 can include a plurality of systems 102-1, 102-2, . . . , 102-N associated with a facility (e.g., building), an application program interface (API) 106, and a computing device 108. The facility can be, for example, a commercial facility, such as a commercial office building. However, embodiments of the present disclosure are not limited to a particular type of facility.

In some embodiments, API 106 and computing device 108 may be part of a management platform, such as a building management system, associated with the facility. The building management system can be used (e.g., by a user, such as an operator, manager, and/or technician, for instance) to manage (e.g., monitor and/or control) the facility. For example, the user can check and/or set the state of control components, equipment, devices, and/or networks associated with the spaces (e.g., areas, rooms, zones, floors, etc.) of the facility using the building management system, as will be appreciated by one of skill in the art.

API 106 can be a set of routines, protocols, and/or tools (e.g., software development tools) specifying how computing device 108 can interact with (e.g., receive data from, as will be further described herein) systems 102-1, 102-2, . . . , 102-N. In the embodiment illustrated in FIG. 1, API 106 is located separate (e.g., remote) from computing device 108, and may be accessed via a wireless connection, for instance. However, in some embodiments, API 106 can be located in (e.g., part of) computing device 108. Further, in some embodiments, computing device 108 may interact with systems 102-1, 102-2, . . . , 102-N without the use of API 106.

Computing device 108 can be, for example, a laptop computer, a desktop computer, or a mobile device (e.g., smart phone, tablet, PDA, etc.). For example, computing device can include a memory, processor, and user interface, as will further be descried herein (e.g., in connection with FIG. 3). However, embodiments of the present disclosure are not limited to a particular type of computing device.

Systems 102-1, 102-2, . . . , 102-N can be existing (e.g., previously installed) data collecting (e.g., data sensing) systems associated with the facility (e.g., existing systems that collect and/or sense data associated with the facility during their normal course of operation). Further, each respective system 102-1, 102-1, . . . , 102-N can be a different type (e.g., different class) of data collecting system. For instance, system 102-1 can be a first type of data collecting system, system 102-2 can be a second type of data collecting system, etc.

Systems 102-1, 102-2, . . . , 102-N may not be systems that have been installed in the facility for the specific purpose of collecting data on the space utilization and/or building management system of the facility. As such, the data collected by systems 102-1, 102-2, . . . , 102-N may not necessarily include data that directly provides information about the space utilization and/or building management system of the facility, such as location-based information associated with the occupants and/or assets of the facility. Rather, the collected data may include data from which such information can be inferred and/or extrapolated.

For example, one of the systems 102-1, 102-2, . . . , 102-N can be an information technology (IT) system associated with the facility. The IT system can include, for instance, a computer logging system that can collect data associated with computer logon events occurring in the facility. Such data can include, for instance, the time occupants of the facility log on to their computers in the facility, unique identifiers for each individual logging on, the duration for which they remain logged on, and the time they log off. Further, this data can include data associated with desktop computer logon events, and/or mobile device (e.g., app) logon events. This data can be mapped through an internet protocol (IP) address mapping system associated with the facility, which can provide an indication of how many people are logged on in different locations throughout the facility. Further, this data can provide an indication of who is logged in at the different locations by matching the unique identifiers for each individual with the locations at which they are logged in. As such, this data can be used to create occupancy patterns in the facility that can provide an increased (e.g., enhanced) awareness and/or understanding of the efficiency and/or effectiveness of the space utilization of the facility. In some embodiments, this data can be anonymized, as will be further described herein.

The IT system may also collect data associated with the use of collaboration spaces, such as meetings rooms and/or conference rooms, occurring in the facility. Such data can include, for instance, data associated with reservations made for the collaboration spaces, such as the times for which the spaces are reserved. This data can provide an indication of when the collaboration spaces are occupied (and when they are not occupied), and hence can be used to create occupancy patterns in the facility that can provide an increased (e.g., enhanced) awareness and/or understanding of the efficiency and/or effectiveness of the space utilization of the facility.

As an additional example, one of the systems 102-1, 102-2, . . . , 102-N can be an access control system associated with the facility. The access control system can be, for instance, a physical access control system that monitors and/or controls (e.g., limits and/or restricts) access (e.g., physical access) to different spaces in the facility by requiring an individual who is attempting to enter the space to present a valid identification token, such as, for instance, a key card, magnetic badge, or wireless identification tag, at the entrance to the location (e.g., to a reader at the entrance) in order to enter the space.

The access control system (e.g., physical access control system) can collect data associated with access events occurring in the facility, such as, for instance, the times people enter different spaces in the facility, the duration for which they are in the space, the time they leave the space, and an identification of who is accessing the space. This data can be collected by, for instance, access logs of the access control system, and can be used to create occupancy patterns in the facility that can provide an increased (e.g., enhanced) awareness and/or understanding of the efficiency and/or effectiveness of the space utilization of the facility.

The efficiency of the space utilization of the facility can refer to and/or include, for instance, the number (e.g., quantity) of people utilizing the spaces, and/or how full the spaces are (e.g., the percent of the spaces' capacity that is being utilized). The effectiveness of the space utilization of the facility can refer to and/or include, for instance, how the spaces are being utilized and/or the quality of the utilization of the spaces, such as how well the spaces of the facility are being utilized relative to the utilization objectives for those spaces regarding people, assets, and/or interactions.

As an additional example, one of the systems 102-1, 102-2, . . . , 102-N can be the building management system associated with the facility. The building management system can collect data associated with interactions (e.g., user interactions) with the building management system occurring in the facility, such as, for instance, a service request, a temperature set point change (e.g., increase or decrease), a safety or evacuation action, a lighting change (e.g., lights being turned on or off), a fan being turned on or off, etc. This data can be collected by the building management system itself, or by applications (e.g., mobile apps) that provide access to the building management system, and can be used to create occupancy patterns of the facility that can provide an increased (e.g., enhanced) awareness and/or understanding of the efficiency and/or effectiveness of the space utilization of the facility.

As an additional example, one of the systems 102-1, 102-2, . . . , 102-N can be a real time location system associated with the facility. The real time location system can be, for instance, a blue tooth, cellular, Wi-Fi, radio frequency (RF), or other wireless communication system that can monitor the real time location of occupants within the facility by collecting real time location data of the occupants in the facility.

For example, the real time location system may include different beacons associated with (e.g., located proximal to) the different spaces of the facility. The beacons can be devices capable of wireless communication with the mobile devices of the occupants of the facility, and can allow for the determination of the location of the mobile devices. For instance, the beacons can allow the determination of whether the mobile device of an occupant is within a particular (e.g., threshold) distance of the beacon and/or the space associated with the beacon.

As an additional example, one of the systems 102-1, 102-2, . . . , 102-N can be a smart ceiling system associated with the facility. The smart ceiling system can include, for instance, sensors located in the light fixtures of the facility that can detect the presence of an occupant in a particular space of the facility, and adjust the lighting and/or temperature settings of the space accordingly.

As shown in FIG. 1, the data collected by systems 102-1, 102-2, . . . , 102-N can be sent to computing device 108 (e.g., computing device 108 can receive the data collected by systems 102-1, 102-2, . . . , 102-N) via a wired or wireless network (e.g., network 104). Network 104 can be, for example, a network relationship through which computing device 108 and systems 102-1, 102-2, . . . , 102-2 can communicate (e.g., using the set of routines, protocols, and/or tools specified by API 106). Examples of such a network relationship can include a distributed computing environment (e.g., a cloud computing environment), a wide area network (WAN) such as the Internet, a local area network (LAN), a personal area network (PAN), a campus area network (CAN), or metropolitan area network (MAN), among other types of network relationships. For instance, the network can include a number of servers that receive the data collected by systems 102-1, 102-2, . . . , 102-N, and transmit the received data to computing device 108 via a wired or wireless network.

As used herein, a “network” can provide a communication system that directly or indirectly links two or more computers and/or peripheral devices and allows users to access resources on other computing devices and exchange messages with other users. A network can allow users to share resources on their own systems with other network users and to access information on centrally located systems or on systems that are located at remote locations. For example, a network can tie a number of computing devices together to form a distributed control network (e.g., cloud).

A network may provide connections to the Internet and/or to the networks of other entities (e.g., organizations, institutions, etc.). Users may interact with network-enabled software applications to make a network request, such as to get a file or print on a network printer. Applications may also communicate with network management software, which can interact with network hardware to transmit information between devices on the network.

Computing device 108 can analyze (e.g., perform and/or provide an analysis of) the space utilization of the facility using the data received from systems 102-1, 102-2, . . . , 102-N. Further, computing device 108 can analyze (e.g., perform and/or provide an analysis of) the effectiveness of the building management system of the facility using the data received from systems 102-1, 102-2, . . . , 102-N.

As such, computing device 108 can analyze the space utilization of the facility, and/or the effectiveness of the building management system of the facility, using data that may not necessarily directly provide information about the space utilization and/or building management system of the facility, such as location-based information associated with the occupants and/or assets of the facility. Rather, computing device 108 can analyze the space utilization of the facility, and/or the building management system of the facility, using data from which such information can be inferred and/or extrapolated.

The space utilization of the facility can refer to and/or include, for instance, how well the spaces of the facility are being utilized relative to the utilization objectives for those spaces regarding people, assets, and/or interactions. For example, the analysis of the space utilization of the facility can include an indication of who is utilizing the different spaces of the facility, such as, for instance, an indication of the type and/or class of the occupants (e.g., the type and/or class of workers and/or employees) utilizing the different spaces of the facility.

As an additional example, the analysis of the space utilization of the facility can include an indication of how often (e.g., the frequency with which) the different spaces of the facility are being utilized. For instance, the analysis can include a heat map of the usage of the spaces that includes different colors representing different amounts and/or densities of space usage.

As an additional example, the analysis of the space utilization of the facility can include an asset movement analysis and/or a work flow analysis for the different spaces of the facility. The asset movement and/or work flow analysis can be domain (e.g., facility) specific.

In some embodiments, computing device 108 can anonymize the data received from systems 102-1, 102-2, . . . , 102-N before analyzing the space utilization of the facility. For example, computing device 108 can remove any individual identification information, such as unique individual identifiers, from the data before analyzing the space utilization of the facility. In such embodiments, the space utilization analysis can be a higher level analysis for the facility, such as a portfolio level analysis, that does not identify individual occupants of the facility, thereby preserving their anonymity in the analysis.

In some embodiments, computing device 108 may not anonymize the data received from systems 102-1, 102-2, . . . , 102-N. In such embodiments, the space utilization analysis may include an identification of (e.g., identify) the individual occupants of the facility, which can provide a greater level of detail, such as a site specific level of detail, of the space utilization of the facility.

The effectiveness of the building management system of the facility can refer to and/or include, for instance, whether the building management system is being used effectively to monitor and/or control the spaces of the building. For example, the analysis of the effectiveness of the building management system of the facility can include an analysis of occupancy based controls, such as energy and/or comfort services and/or workflows, performed by the building management system. For instance, the analysis can indicate whether the building management system is effectively (e.g., promptly) turning lights off in a space if no one is present in the space.

As an additional example, the analysis of the effectiveness of the building management system of the facility can include an analysis of location based controls, such as safety and/or security services and/or workflows, performed by the building management system. For instance, if a fire detector (e.g., smoke alarm) has gone off in a space of the facility, the analysis can include an analysis of the building management system's effectiveness in directing the prompt and safe evacuation of the space, such as changing access controls as needed to allow for the evacuation. Further, the analysis can include an analysis of the building management system's effectiveness in directing the first responder(s) to the fire in a safe manner, and/or the building management system's effectiveness in changing the operation of the HVAC system of the facility to account for (e.g., contain and/or extinguish) the fire.

Further, the analysis of the space utilization of the facility and the effectiveness of the building management system of the facility can include a quantifiable connection between the space utilization of the facility and the building management system. For instance, the analysis can include a quantifiable connection that indicates how a change in the occupancy and/or movement of people in the facility may affect the building management system of the facility, such as, for instance, effects on the HVAC settings of the facility, safety evacuations of the facility, geo-fencing security for assets of the facility, and/or security tracking of people in the facility.

Computing device 108 can provide the analysis of the space utilization of the facility and/or the analysis of the effectiveness of the building management system of the facility to a user (e.g., a user of computing device 108). The user may be, for example, an operator, manager, and/or technician of the building management system of the facility.

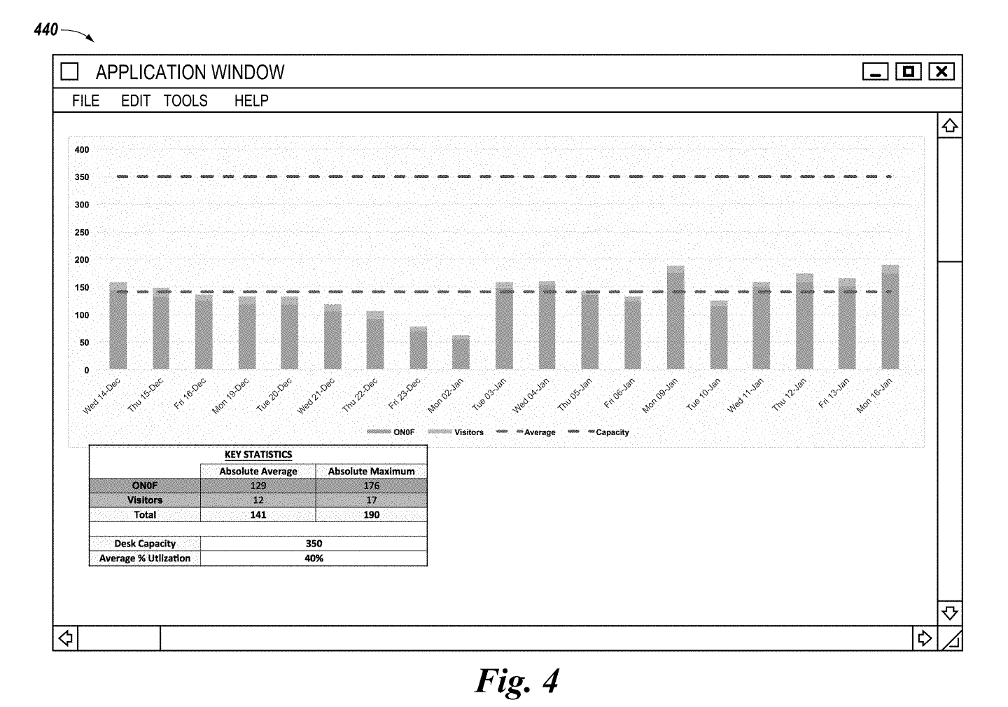

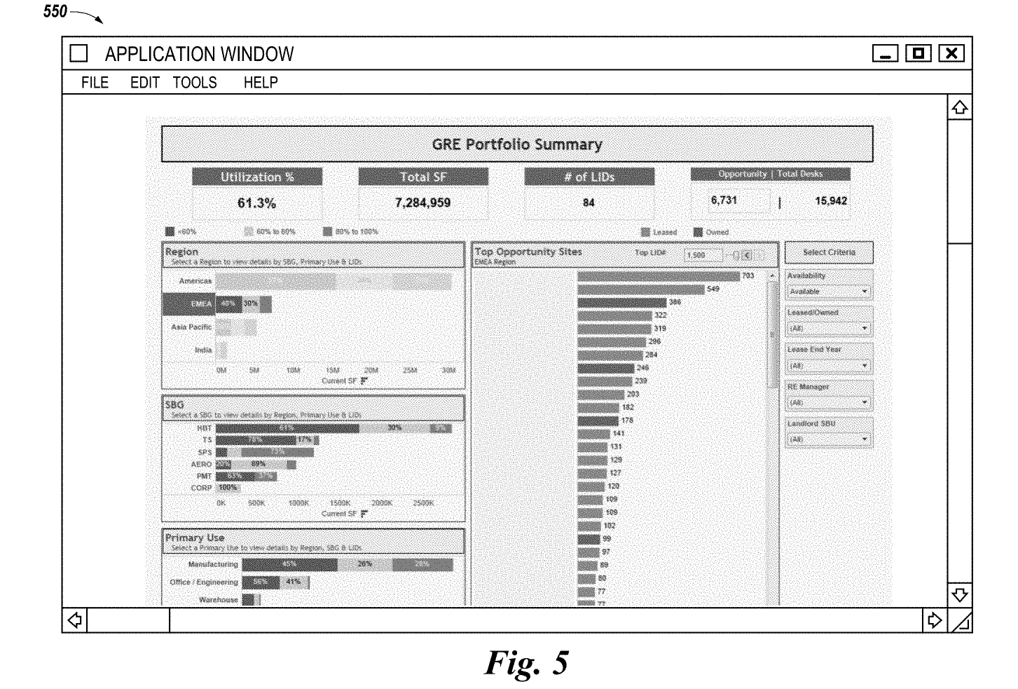

As an example, computing device 108 can provide the analysis to the user by displaying the analysis on a user interface of the computing device, as will be further described herein (e.g., in connection with FIG. 3). As an additional example, computing device 108 can provide the analysis to the user by sending (e.g., transmitting) the analysis to an additional computing device, such as a mobile device of the user, on which the analysis can be displayed. Computing device 108 can send the analysis to the additional device via network 104, or via an additional wired or wireless network. Examples of such analyses that can be provided to the user will be further described herein (e.g., in connection with FIGS. 4-5).

Although the examples of space utilization and building management system analysis described herein have referred to a (e.g., one) facility, embodiments of the present disclosure are not so limited. For example, embodiments of the present disclosure can be used to analyze space utilization and/or building management systems of a plurality of facilities. For instance, embodiments of the present disclosure can determine and/or analyze the space utilization across an entire portfolio of facilities, which can create and/or provide an increased awareness and/or understanding of the space utilization across the portfolio, with the ability to dissect and analyze subsets of that portfolio of facilities by, for instance, capturing space utilization by a particular business group or job function within and/or across the portfolio to identify utilization efficiency opportunities for the portfolio.

For example, computing device 108 can receive data from existing data collection systems associated with a plurality of facilities that are analogous to systems 102-1, 102-2, . . . , 102-N (e.g., the data received from the existing data collection systems associated with the plurality of facilities can be analogous to the data received from systems 102-1, 102-2, . . . , 102-N). Computing device 108 can then analyze the space utilization of the plurality of facilities, and/or the effectiveness of the building management systems of the facilities, using the data, and provide the analysis to a user, in a manner analogous to that previously described herein.

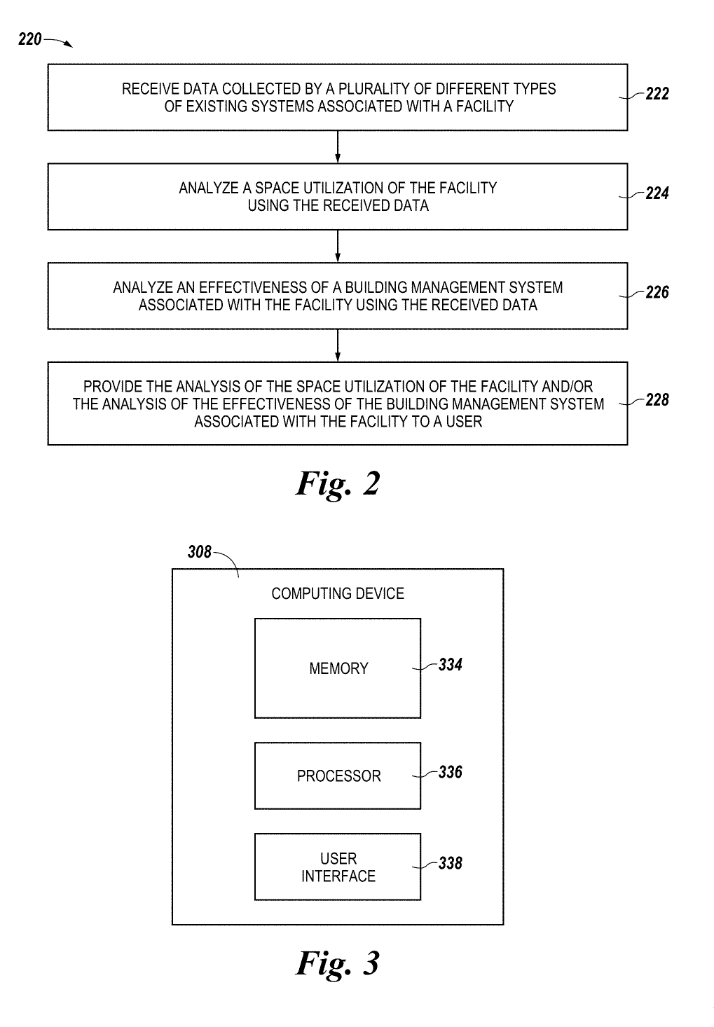

FIG. 2 illustrates an example of a method 220 for space utilization and building management system analysis in accordance with one or more embodiments of the present disclosure. Method 220 can be performed by a computing device, such as, for instance, computing device 208 previously described in connection with FIG. 1.

At block 222, method 220 includes receiving data collected by a plurality of existing systems associated with a facility. The plurality of existing systems can be, for example, systems 102-1, 102-2, . . . , 102-N previously described in connection with FIG. 1, and the data collected by the systems can include data analogous to that previously described herein (e.g., in connection with FIG. 1). Further, the data can be received via a wired or wireless network, such as network 104, as previously described in connection with FIG. 1.

At block 224, method 220 includes analyzing a space utilization of the facility using the received data. At block 226, method 220 includes analyzing an effectiveness of a building management system associated with the facility using the received data. The analysis of the space utilization of the facility and the analysis of the effectiveness of the building management system associated with the facility can be analogous to that previously described herein (e.g., in connection with FIG. 1).

At block 226, method 220 includes providing the analysis of the space utilization of the facility and/or the analysis of the effectiveness of the building management system associated with the facility to a user. The analysis can be provided to the user in a manner analogous to that previously described herein (e.g., in connection with FIG. 1).

FIG. 3 illustrates an example of a computing device 308 for space utilization and building management system analysis in accordance with one or more embodiments of the present disclosure. Computing device 308 can be, for example, computing device 108 previously described in connection with FIG. 1.

As shown in FIG. 3, computing device 308 can include a memory 334 and a processor 336. Memory 334 can be any type of storage medium that can be accessed by processor 336 to perform various examples of the present disclosure. For example, memory 334 can be a non-transitory computer readable medium having computer readable instructions (e.g., computer program instructions) stored thereon that are executable by processor 336 to perform space utilization and building management system analysis in accordance with the present disclosure. That is, processor 336 can execute the executable instructions stored in memory 334 to perform space utilization and building management system analysis in accordance with the present disclosure.

Memory 334 can be volatile or nonvolatile memory. Memory 334 can also be removable (e.g., portable) memory, or non-removable (e.g., internal) memory. For example, memory 334 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disk read-only memory (CD-ROM)), flash memory, a laser disk, a digital versatile disk (DVD) or other optical disk storage, and/or a magnetic medium such as magnetic cassettes, tapes, or disks, among other types of memory.

Further, although memory 334 is illustrated as being located in computing device 308, embodiments of the present disclosure are not so limited. For example, memory 334 can also be located internal to another computing resource (e.g., enabling computer readable instructions to be downloaded over the Internet or another wired or wireless connection).

As shown in FIG. 3, computing device 308 can include a user interface 346. A user (e.g., operator) of computing device 308, such as, for instance, an operator, manager, and/or technician of a building management system, can interact with computing device 308 via user interface 338. For example, user interface 338 can provide (e.g., display and/or present) information to the user of computing device 308, such as, for instance, an analysis of the space utilization of a facility and/or an analysis of the effectiveness of a building management system associated with the facility, as previously described herein. Further, user interface 338 can receive information from (e.g., input by) the user of computing device 308.

In some embodiments, user interface 338 can be a graphical user interface (GUI) that can include a display (e.g., a screen) that can provide and/or receive information to and/or from the user of computing device 308. The display can be, for instance, a touch-screen (e.g., the GUI can include touch-screen capabilities). As an additional example, user interface 338 can include a keyboard and/or mouse the user can use to input information into computing device 308. Embodiments of the present disclosure, however, are not limited to a particular type(s) of user interface.

FIG. 4 illustrates an example of a space utilization analysis 440 provided (e.g., displayed) to a user in accordance with one or more embodiments of the present disclosure. The analysis can be performed and provided to the user by, for example, computing device 108, as previously described herein.

Space utilization analysis 440 illustrated in FIG. 4 includes a graphical representation of the daily space (e.g., desk) utilization of a facility over a plurality of days. For example, the graphical representation can indicate the total number of desks being utilized at the facility on each respective day, as illustrated in FIG. 4. Further, for the total number of desks being utilized on each respective day, the graphical representation can indicate how many of those desks are being utilized by employees of the facility, and how may are being utilized by visitors to the facility, as illustrated in FIG. 4. Further, the graphical representation can indicate the average number of desks being utilized per day, and the total desk capacity of the facility.

Space utilization analysis 440 illustrated in FIG. 4 also includes a statistical (e.g., numerical) representation of the desk utilization of the facility. For example, the statistical representation can include numerical values for the average number of desks being utilized at the facility per day, including the average number of desks utilized by employees per day, the average number of desks utilized by visitors per day, and the combined total, as illustrated in FIG. 4. Further, the statistical representation can include the daily maximum number of desks utilized at the facility, including the daily maximum for employees, visitors, and the total daily maximum, as illustrated in FIG. 4. Further, the statistical representation can include a numerical value for the total desk capacity of the facility, and a percentage value for the average number of desks being utilized per day.

FIG. 5 illustrates an example of a space utilization analysis 550 provided (e.g., displayed) to a user in accordance with one or more embodiments of the present disclosure. The analysis can be performed and provided to the user by, for example, computing device 108, as previously described herein.

Space utilization analysis 550 illustrated in FIG. 5 is a summary of the space (e.g., desk) utilization of a plurality (e.g., portfolio) of facilities from around the world. For example, the summary can include numerical values for the total (e.g., combined) number of desks being utilized at the facilities and the total number of desks actually located at the facilities, as illustrated in FIG. 5. Further, the summary can include a percentage value for the total number of desks being utilized, as illustrated in FIG. 5.

As shown in FIG. 5, the summary can also include various graphical representations of the desk utilization of the facilities, arranged (e.g., sorted) by according to different factors. For example, the summary can include graphical representations of the desk utilization of the facilities arranged by the region of the world in which the facilities are located, the business type (e.g., group) to which the facilities belong, the primary use of the facilities, and site of the facilities, as illustrated in FIG. 5.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A computing device for space utilization analysis, comprising:
a memory; and
a processor configured to execute executable instructions stored in the memory to:
receive data collected by a plurality of different types of existing systems associated with a facility;
analyze a space utilization of the facility using the received data; and
provide the analysis of the space utilization of the facility to a user.

2. The computing device of claim 1, wherein one of the plurality of different types of existing systems associated with the facility is an information technology system associated with the facility.

3. The computing device of claim 1, wherein one of the plurality of different types of existing systems associated with the facility is a physical access control system associated with the facility.

4. The computing device of claim 1, wherein one of the plurality of different types of existing systems associated with the facility is a building management system associated with the facility.

5. The computing device of claim 1, wherein one of the plurality of different types of existing systems associated with the facility is a real time location system associated with the facility.

6. The computing device of claim 1, wherein one of the plurality of different types of existing systems associated with the facility is a smart ceiling system associated with the facility.

7. The computing device of claim 1, wherein the processor is configured to execute the instructions to:
receive data collected by a plurality of different types of existing systems associated with a plurality of facilities;
analyze a space utilization of the plurality of facilities using the received data; and
provide the analysis of the space utilization of the plurality of facilities to a user.

8. A method for building management system analysis, comprising:
receiving, by a computing device, data collected by a plurality of different types of existing systems associated with a facility;
analyzing, by a computing device, an effectiveness of a building management system associated with the facility using the received data; and
providing, by the computing device, the analysis of the effectiveness of the building management system associated with the facility to a user.

9. The method of claim 8, wherein the data collected by the plurality of different types of existing systems associated with the facility includes data associated with computer logon events occurring in the facility.

10. The method of claim 8, wherein the data collected by the plurality of different types of existing systems associated with the facility includes data associated with access events occurring in the facility.

11. The method of claim 8, wherein the data collected by the plurality of different types of existing systems associated with the facility includes data associated with interactions with the building management system occurring in the facility.

12. The method of claim 8, wherein the data collected by the plurality of different types of existing systems associated with the facility includes data associated with uses of collaboration spaces occurring in the facility.

13. The method of claim 8, wherein the data collected by the plurality of different types of existing systems associated with the facility includes:
real time location data of occupants in the facility; and
data indicating a presence of an occupant in an area of the facility.

14. The method of claim 8, wherein the method includes receiving, by the computing device, the data collected by the plurality of different types of existing systems associated with the facility via a distributed control network.

15. A non-transitory computer readable medium having computer readable instructions stored thereon that are executable by a processor to:
receive data collected by a plurality of different types of existing systems associated with a facility;
analyze a space utilization of the facility using the received data;
analyze an effectiveness of a building management system associated with the facility using the received data; and
provide the analysis of the space utilization of the facility and the analysis of the effectiveness of the building management system associated with the facility to a user.

16. The computer readable medium of claim 15, wherein the analysis of the space utilization of the facility includes:
an indication of who is utilizing different spaces of the facility; and
an indication of how often the different spaces of the facility are being utilized.

17. The computer readable medium of claim 15, wherein the analysis of the space utilization of the facility includes:
an asset movement analysis for different spaces of the facility; and
a work flow analysis for the different spaces of the facility.

18. The computer readable medium of claim 15, wherein the analysis of the effectiveness of the building management system associated with the facility includes an analysis of occupancy based controls performed by the building management system.

19. The computer readable medium of claim 15, wherein the analysis of the effectiveness of the building management system associated with the facility includes an analysis of location based controls performed by the building management system.

20. The computer readable medium of claim 15, wherein the analysis of the space utilization of the facility and the analysis of the effectiveness of the building management system associated with the facility includes a quantifiable connection between the space utilization of the facility and the building management system associated with the facility.
